(19) United States
(12) Patent Application Publication
(10) Pub. No.: US 2026/0004561 A1
(43) Pub. Date: Jan. 1, 2026

(54) COMPUTER PROGRAM, INFORMATION PROCESSING METHOD, AND INFORMATION PROCESSING DEVICE

(71) Applicant: Tokyo Electron Limited, Tokyo (JP)

(72) Inventors: Tsuyoshi MIZUUCHI, Sapporo-shi (JP); Takahiko KATO, Miyagi (JP)

(73) Assignee: Tokyo Electron Limited, Tokyo (JP)

(21) Appl. No.: 19/317,192

(22) Filed: Sep. 3, 2025

Related U.S. Application Data
(63) Continuation of application No. PCT/JP2024/007667, filed on Mar. 1, 2024.

(30) Foreign Application Priority Data
Mar. 6, 2023 (JP) 2023-033779

(51) Int. Cl. G06V 10/764; G06T 7/10; G06V 10/74; G06V 10/762

(52) U.S. Cl. CPC G06V 10/764; G06T 7/10; G06V 10/761; G06V 10/762

(57) ABSTRACT

The present disclosure provides a computer program, an information processing method, and an information processing device that visualize a relationship among a plurality of processing steps. The computer program causes a computer to acquire processing step groups obtained by classifying processing steps executed for processing a substrate based on a range of values of parameters for defining contents of the processing steps, and display a graphic image representing each processing step group at positions corresponding to the values of the parameters related to each processing step group in a two-dimensional or three-dimensional coordinate space obtained by dimensionally compressing a multi-dimensional space represented using the parameters.

### CROSS-REFERENCE TO RELATED APPLICATIONS

This application is a bypass continuation application of international application No. PCT/JP2024/007667 having an international filing date of Mar. 1, 2024 and designating the United States, the international application being based upon and claiming the benefit of priority from Japanese Patent Application No. 2023-033779, filed on Mar. 6, 2023, the entire contents of each are incorporated herein by reference.

### TECHNICAL FIELD

The present disclosure relates to a computer program, an information processing method, and an information processing device.

### BACKGROUND

Substrate processing which involves etching, film formation, or the like on a substrate such as a semiconductor wafer is executed according to a recipe that defines processing contents. The recipe is a combination of a plurality of processing steps in a set order, and processing contents of each processing step are set. The processing step is a smallest unit of substrate processing. A desired recipe may be searched by recording recipes devised in the past and adjusting contents of processing steps included in the recipes.

Contents of a processing step are defined by a plurality of parameters. The plurality of parameters include, for example, a processing condition of the substrate processing. A multi-dimensional coordinate space having a combination of values of a plurality of parameters as coordinates is considered. Hereinafter, this coordinate space will be referred to as a process space. Processing steps may be represented as points in the process space. PTL 1 discloses an example of a technique for dividing a process space into many small spaces and managing a processing step included in each small space.

### CITATION LIST

### Patent Documents

PTL 1: JP2021-5694A

### SUMMARY

With the development of technology, the number of recipes, the number of processing steps included in a recipe, and the number of parameters of a processing step increase, and it is required to manage enormous amounts of information. Therefore, it is difficult to recognize a relationship among processing steps.

The present disclosure provides a computer program, an information processing method, and an information processing device that visualize a relationship among a plurality of processing steps.

According to one aspect of the present disclosure, the computer program causes a computer to acquire processing step groups obtained by classifying processing steps executed for processing a substrate based on a range of values of parameters for defining contents of the processing steps, and display a graphic image representing each processing step group at positions corresponding to the values of the parameters related to each processing step group in a two-dimensional or three-dimensional coordinate space obtained by dimensionally compressing a multi-dimensional space represented using the plurality of parameters.

According to the present disclosure, a computer program, an information processing method, and an information processing device that visualize a relationship among a plurality of processing steps can be provided.

### BRIEF DESCRIPTION OF DRAWINGS

FIG. 1 is a conceptual diagram illustrating a configuration example of an information processing system according to the present embodiment;

FIG. 2 is a block diagram illustrating an internal configuration example of an information processing device;

FIG. 3 is a conceptual diagram illustrating an example of contents of recipe data;

FIG. 4 is a conceptual diagram illustrating an example of a process space;

FIG. 5 is a schematic diagram illustrating an example of one processing step group in the process space;

FIG. 6 is a flowchart illustrating an example of a processing procedure for displaying a relationship among processing steps, which is executed by the information processing device;

FIG. 7 is a conceptual diagram illustrating an example of contents of Proxel data;

FIG. 8 is a table illustrating an example of a plurality of parameters related to two Proxels;

FIG. 9 is a table illustrating an example of a distance defined between two types of gases;

FIG. 10 is a table illustrating an example of a distance according to a difference in combination of gases;

FIG. 11 is a schematic diagram illustrating an example of a two-dimensional coordinate space that includes a plurality of graphic images;

FIG. 12 is a schematic diagram illustrating an example of graphic images of which colors are adjusted according to a Loss value in an experiment and a Loss value in a simulation;

FIG. 13 is a flowchart illustrating an example of a processing procedure for changing display of a graphic image, which is executed by the information processing device;

FIG. 14 is a schematic diagram illustrating an example of a two-dimensional coordinate space in which Proxels for displaying graphic images are narrowed down;

FIG. 15 is a schematic diagram illustrating an example of a two-dimensional coordinate space in which some graphic images are highlighted; and

FIG. 16 is a schematic diagram illustrating a display example of contents of a processing step.

### DETAILED DESCRIPTION

Hereinafter, the disclosure will be specifically described with reference to the drawings illustrating an embodiment thereof.

A process for producing a substrate such as a semiconductor wafer, a glass substrate, or a flat panel substrate includes a process of performing processing such as etching or film formation on the substrate. Hereinafter, the processing performed on the substrate will be referred to as substrate processing, and a device for executing the substrate processing will be referred to as a processing device. For example, the processing device includes a process chamber, and executes the substrate processing, such as etching and film formation, on a substrate disposed in the process chamber. The processing device processes the substrate according to a predetermined recipe. The recipe is information for defining contents of the substrate processing, and includes a plurality of processing steps whose order is determined. Each processing step is a smallest unit of a time series processing procedure for the substrate. In each processing step, contents of processing to be performed on the substrate are determined. Some of the plurality of processing steps included in a plurality of recipes have substantially the same contents, and some have completely different contents. In the present embodiment, information processing is executed to visualize a relationship among a plurality of processing steps.

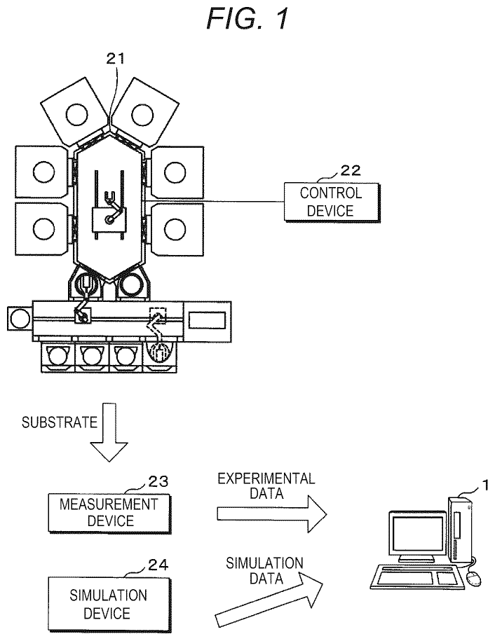

FIG. 1 is a conceptual diagram illustrating a configuration example of an information processing system according to the present embodiment. The information processing system includes a processing device 21 that executes substrate processing, a control device 22 that controls the processing device 21, a measurement device 23 that measures a shape of a substrate, a simulation device 24, and an information processing device 1. The processing device 21 includes, for example, a process chamber, and executes substrate processing such as etching or film formation. The control device 22 adjusts a processing condition for the substrate processing executed by the processing device 21. The processing condition defines contents of the substrate processing executed according to a processing step. The control device 22 adjusts a processing condition according to the contents of the processing step, and the processing device 21 executes the substrate processing according to the processing step by executing the substrate processing under the adjusted processing condition. For example, the processing device 21 executes the substrate processing according to any one processing step included in any one recipe, thereby executing an experiment in the processing step.

The measurement device 23 measures a shape of the substrate. The measurement device 23 is, for example, a scanning electron microscope or a transmission electron microscope. For example, the substrate is cut, and a cross-sectional shape of the substrate is measured by the measurement device 23. For example, the shape of the substrate is measured after the substrate processing according to a certain processing step is executed. After an experiment in which the processing device 21 executes the substrate processing according to a processing step, the measurement device 23 measures the shape of the substrate, thereby obtaining an experimental result of the processing step. The experimental result includes the shape of the substrate obtained through the experiment. The shape of the substrate may be measured by the measurement device 23 before the processing device 21 executes the substrate processing according to the processing step.

The simulation device 24 executes a shape simulation to predict the shape of the substrate obtained through the substrate processing executed according to the processing step. The simulation device 24 is implemented by a computer, and executes the shape simulation according to a computer program. In the shape simulation, a simulation for executing the substrate processing according to any one processing step is executed for a substrate having any shape, and a predicted shape obtained by predicting the shape of the substrate obtained through the substrate processing is calculated. The simulation device 24 may execute a shape simulation using a trained model that outputs a predicted shape when a shape of the substrate and contents of the processing step are input. For example, the trained model is implemented by a neural network.

The simulation device 24 executes a simulation for a processing step by executing a shape simulation for predicting a shape of the substrate obtained through the substrate processing executed according to any processing step included in any recipe. Information indicating contents of the processing step is input into the simulation device 24, and the simulation device 24 executes the shape simulation based on the input information. For example, the information indicating contents of the processing step is input from the control device 22 to the simulation device 24. The simulation device 24 generates a simulation result of the processing step by executing a simulation for the processing step. The simulation result includes a predicted shape obtained by predicting a shape of the substrate obtained by the substrate processing executed according to the processing step.

The information processing device 1 executes an information processing method. The information processing device 1 stores a plurality of pieces of recipe data related to a plurality of recipes. The recipe data includes contents of each processing step, and the contents of the processing step may include a processing result of the processing step. The processing result of the processing step includes an experimental result of the processing step or a simulation result of the processing step. The experimental result of the processing step is input from the measurement device 23 to the information processing device 1. The simulation result of the processing step is input from the simulation device 24 to the information processing device 1. Contents of the processing step may be input from the control device 22 to the information processing device 1. Based on the recipe data, the information processing device 1 executes information processing to visualize a relationship among processing steps.

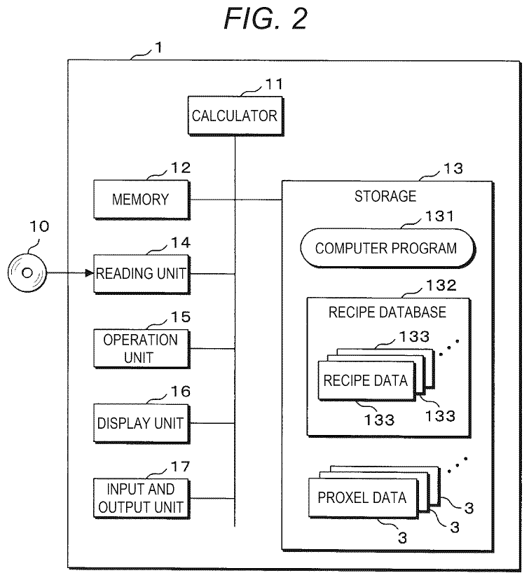

FIG. 2 is a block diagram illustrating an internal configuration example of the information processing device 1. The information processing device 1 is implemented using a computer such as a personal computer or a server apparatus. The information processing device 1 includes a calculator 11, a memory 12, a storage 13, a reading unit 14, an operation unit 15, a display unit 16, and an input and output unit 17. The calculator 11 is implemented using, for example, a central processing unit (CPU), a graphics processing unit (GPU), or a multi-core CPU. The calculator 11 may also be implemented using a quantum computer. The memory 12 stores temporary data generated along with calculation. The memory 12 is, for example, a random access memory (RAM). The storage 13 is non-volatile, and is, for example, a hard disk or a non-volatile semiconductor memory. The reading unit 14 reads information from a recording medium 10 such as an optical disk or a portable memory.

The operation unit 15 receives an input of information such as text by receiving an operation from a user. The operation unit 15 is, for example, a keyboard, a pointing device, or a touch panel. The display unit 16 displays an image. The display unit 16 is, for example, a liquid crystal display or an electroluminescent display (EL display). The operation unit 15 and the display unit 16 may be integrated. The input and output unit 17 inputs and outputs data. The input and output unit 17 is, for example, an input and output interface or a communication unit. The input and output unit 17 receives an input of data.

The calculator 11 causes the reading unit 14 to read a computer program (program product) 131 recorded in the recording medium 10, and causes the storage 13 to store the read computer program 131. The calculator 11 executes processing for implementing functions of the information processing apparatus 1 according to the computer program 131. The computer program 131 may be stored in advance in the storage 13 or may be downloaded from outside the information processing apparatus 1. In this case, the information processing apparatus 1 does not need to be provided with the reading unit 14.

The computer program 131 may be loaded to be executed on a single computer or on a plurality of computers disposed at one site or distributed across a plurality of sites and interconnected by a communication network. That is, the information processing apparatus 1 may be implemented by a plurality of computers, and the computer program 131 may be executed on the plurality of computers connected via the communication network. The information processing apparatus 1 may be implemented using a cloud server.

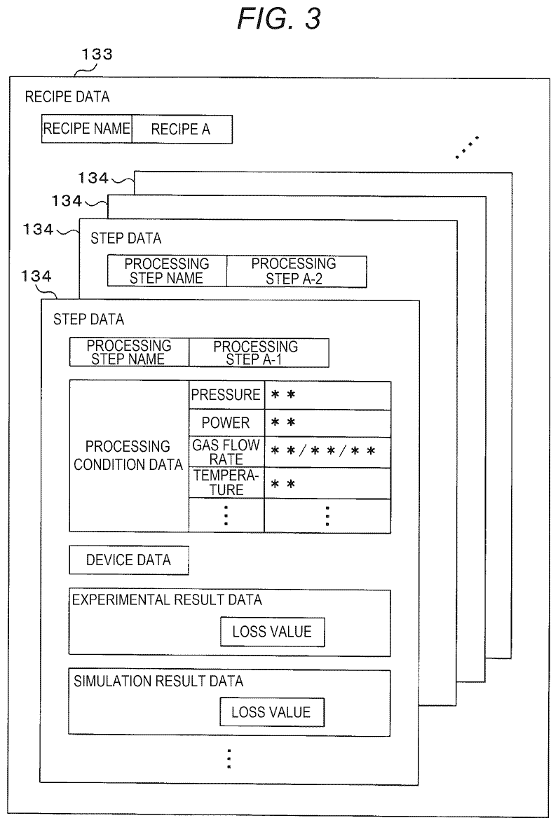

The storage 13 stores a recipe database 132 in which recipe data is recorded. A plurality of pieces of recipe data 133 representing a plurality of recipes are recorded in the recipe database 132. One piece of recipe data 133 is recorded for one recipe. FIG. 3 is a conceptual diagram illustrating an example of contents of the recipe data 133. The recipe data 133 includes a recipe name. FIG. 3 illustrates an example in which the recipe name is recipe A. The recipe data 133 includes step data 134 related to a plurality of processing steps included in a recipe.

The step data 134 includes various kinds of data related to processing steps. The step data 134 includes a processing step name. FIG. 3 illustrates an example in which the processing step name is processing step A-1 or processing step A-2. The step data 134 includes data representing contents of information processing executed in a processing step. The step data includes processing condition data representing a processing condition for the substrate processing as the data representing contents of information processing executed in a processing step. In the processing condition data, data representing a plurality of types of processing conditions are recorded. In the example illustrated in FIG. 3, a pressure in the process chamber, power supplied to the process chamber during the substrate processing, flow rates of a plurality of types of gases supplied to the process chamber, and a temperature in the process chamber are recorded in the processing condition data. The processing condition data may define a processing condition other than pressure, power, gas flow rate, and temperature.

The step data 134 includes device data recording information related to the processing device 21 that executes the substrate processing. The device data records, for example, information related to a type, a structure, a specification, or a state of the processing device 21. For example, a size of a gap between two electrodes provided in the process chamber is recorded as the information related to the structure of the processing device 21. For example, the presence or absence of scratches or contamination in the process chamber is recorded as the information related to the state of the processing device 21.

The step data 134 includes experimental result data representing an experimental result of the substrate processing executed according to a processing step. In an experiment, the substrate processing is executed under a processing condition indicated by the processing condition data. For example, the experiment is executed by the processing device 21, and the experimental result is input from the measurement device 23 to the information processing device 1. The experimental result data may include data representing an experimental result obtained by other methods. The experimental result data includes data representing a shape of the substrate obtained through an experiment. The data representing the shape of the substrate may include an image. The experimental result data may include data representing results of an experiment executed multiple times, or may include the number of times of execution of an experiment. The experimental result data includes a Loss value of the experiment, which is an output value of a loss function for calculating a deviation between a target shape of the substrate to be obtained through the substrate processing executed according to a processing step and a shape of the substrate obtained through an experiment. As the Loss value of the experiment increases, the difference between an experimental result and the target shape increases.

The step data 134 stores simulation result data representing a result obtained by simulating the substrate processing executed according to a processing step. The simulation is a shape simulation in which the substrate processing executed under a processing condition indicated by the processing condition data is simulated to calculate a predicted shape. For example, the shape simulation is executed by the simulation device 24, and a simulation result is input from the simulation device 24 to the information processing device 1. The simulation result data may include data representing a simulation result obtained by other methods. For example, the simulation result data may include data representing a result of a shape simulation executed by the information processing device 1.

The simulation result data includes data representing a predicted shape of the substrate calculated by the shape simulation. The simulation result data may include data representing results of a shape simulation executed a plurality of times, or may include the number of times of execution of the shape simulation. The simulation result data includes a Loss value of a simulation, which is an output value of a loss function that calculates a deviation between the target shape and the predicted shape calculated by the shape simulation. As the Loss value of the simulation increases, the difference between the result of the shape simulation and the target shape increases.

The step data may include both the experimental result data and the simulation result data, or may include only one of the experimental result data and the simulation result data. The recipe data or the step data includes the order in which the substrate processing is executed according to each processing step included in a recipe. The recipe data or the step data may further include other information.

The information processing executed by the information processing device 1 will be described. Here, a multi-dimensional process space having coordinates of combinations of values of a plurality of parameters for defining contents of processing steps is considered. The plurality of parameters for defining contents of processing steps are, for example, a plurality of types of processing conditions recorded in the processing condition data. The plurality of parameters may include processing results of processing steps. For example, the plurality of parameters may include various values included in the experimental result data or the simulation result data included in the step data 134.

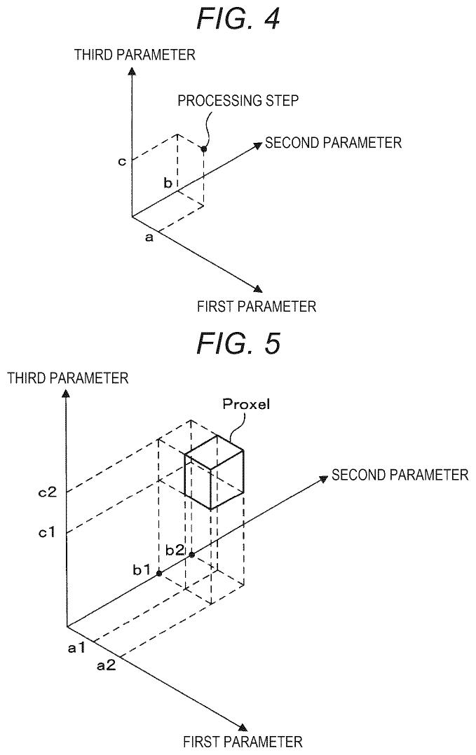

FIG. 4 is a conceptual diagram illustrating an example of a process space. FIG. 4 illustrates a three-dimensional process space where coordinates include a first parameter, a second parameter, and a third parameter. In practice, the process space has more than three dimensions. When values of the first parameter, the second parameter, and the third parameter in a processing step are defined by a, b, and c, respectively, a processing step is represented as a point in the process space located at a position of coordinates (a, b, c).

A plurality of processing steps are considered to be classified into a plurality of processing step groups based on parameters. Processing steps for which values of the respective parameters fall within a predetermined range are classified into one processing step group. FIG. 5 is a schematic diagram illustrating an example of one processing step group in the process space. Processing steps for which the first parameter is included in a range of a1 to a2, the second parameter is included in a range of b1 to b2, and the third parameter is included in a range of c1 to c2 are classified into one processing step group. The processing step group is represented as a small space obtained by dividing the process space. The small space is a process space obtained by dividing a portion where the first parameter is included in the range of a1 to a2, the second parameter is included in the range of b1 to b2, and the third parameter is included in the range of c1 to c2.

Hereinafter, a processing step group represented by a small space in the process space will be referred to as a Proxel. This term is used to define a smallest unit of an image (picture element) as a Pixel, and define a smallest unit of a solid (volume element) as a Voxel. The Proxel is a smallest unit of data related to the substrate processing. The Proxel corresponds to a processing step group that includes a plurality of processing steps included in a plurality of different recipes.

By using the Proxel, a plurality of processing steps whose contents are substantially the same and in which similar processing results can be obtained can be collectively handled as one unit. The Proxel may include only a single processing step. The process space includes a plurality of Proxels. Since the process space is a multi-dimensional space, it is difficult to visualize disposition of the Proxels in the process space. The information processing device 1 executes information processing to visualize a relationship among a plurality of processing steps by displaying the Proxels in a two-dimensional space.

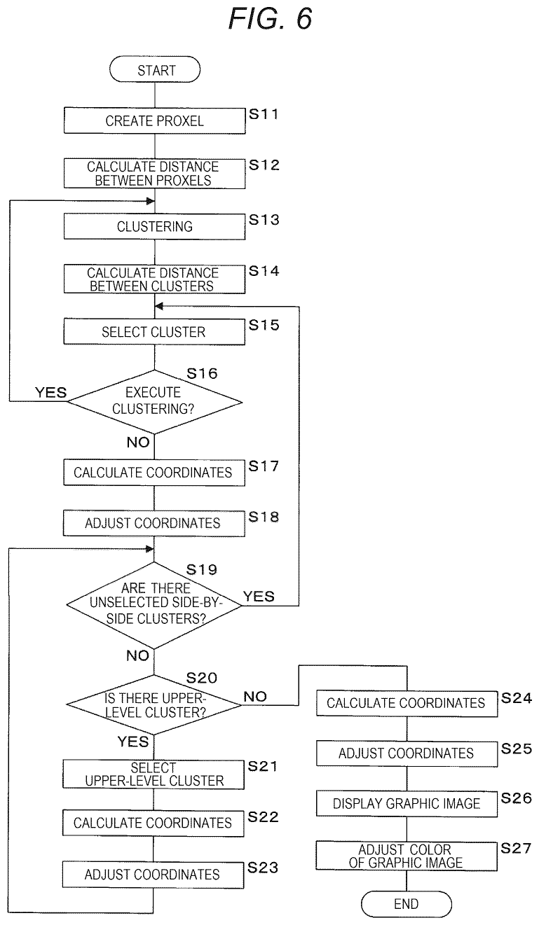

FIG. 6 is a flowchart illustrating an example of a processing procedure for displaying a relationship among processing steps, which is executed by the information processing device 1. Hereinafter, the step of the information processing executed by the information processing device 1 will be abbreviated as S. The information processing apparatus 1 executes the following processing by the calculator 11 executing the information processing according to the computer program 131.

The information processing device 1 creates a plurality of Proxels based on a plurality of pieces of recipe data 133 (S11). In S11, the calculator 11 specifies processing steps included in each Proxel, based on which of a plurality of predetermined ranges values of parameters for defining the processing steps fall within. The plurality of parameters for defining the processing steps are set in advance. For example, the plurality of parameters for defining contents of the processing steps are a plurality of types of processing conditions recorded in the processing condition data or information related to the processing device 21 recorded in the device data. The predetermined ranges of the values of the plurality of parameters of the processing steps to be included in each Proxel are determined in advance and stored in the storage 13.

The calculator 11 reads the processing condition data or the device data from the step data 134, and specifies processing steps for which the values of the plurality of parameters are included in a predetermined range related to each Proxel. The calculator 11 collects the specified plurality of processing steps to create a Proxel. For example, the calculator 11 creates the Proxel by creating Proxel data that includes a plurality of pieces of step data 134 related to the specified plurality of processing steps. In this manner, the calculator 11 creates a plurality of Proxels. Some parameters may be missing for processing steps included in the Proxel. For example, even when values of the parameters with the number less than a predetermined number or less than a predetermined ratio among the plurality of parameters for defining a processing step are undetermined, the processing step may be included in the Proxel as long as values of the other parameters are included in a predetermined range related to the Proxel.

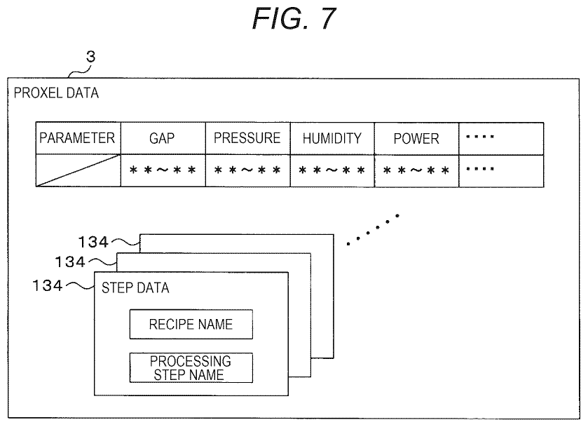

The calculator 11 stores, in the storage 13, a plurality of pieces of Proxel data 3 representing a plurality of Proxels. FIG. 7 is a conceptual diagram illustrating an example of contents of the Proxel data 3. A range of each parameter such as a gap, a pressure, a temperature, and power is recorded in the Proxel data 3. The gap is one kind of information about the processing device 21 recorded in the device data, and indicates a size of a gap between two electrodes in the process chamber. The pressure, the temperature, and the power are processing conditions recorded in the processing condition data. The Proxel data 3 includes a plurality of pieces of step data 134 related to a plurality of processing steps included in the Proxel. The step data 134 includes a name of a recipe that includes a processing step and a name of the processing step. The Proxel data 3 may include information for referring to the step data 134 recorded in the recipe database 132, instead of the step data 134 itself. The plurality of parameters may include processing results of processing steps.

The information processing device 1 acquires a plurality of processing step groups by creating a plurality of Proxels in S11. The information processing device 1 may acquire a plurality of processing step groups by inputting Proxels from the outside, instead of creating the Proxels. For example, another information processing device creates the Proxels, and the plurality of pieces of Proxel data 3 are input into the information processing device 1 via the input and output unit 17, thereby enabling the information processing device 1 to acquire a plurality of processing step groups. The calculator 11 stores the plurality of pieces of input Proxel data 3 in the storage 13.

Next, the information processing device 1 calculates a distance between Proxels based on the values of a plurality of parameters for defining processing steps included in each Proxel (S12). In S12, the calculator 11 calculates the distance between Proxels based on a difference in the values of the plurality of parameters between two Proxels. More specifically, the calculator 11 calculates a difference in each parameter between the two Proxels, sums the calculated differences for a plurality of parameters, and sets an obtained value as the distance between Proxels. A value of each parameter used for the calculation is a representative value within a range related to each Proxel, or is a value in a representative processing step included in each Proxel. The calculator 11 calculates the distance between Proxels for all combinations of two Proxels included in a plurality of Proxels.

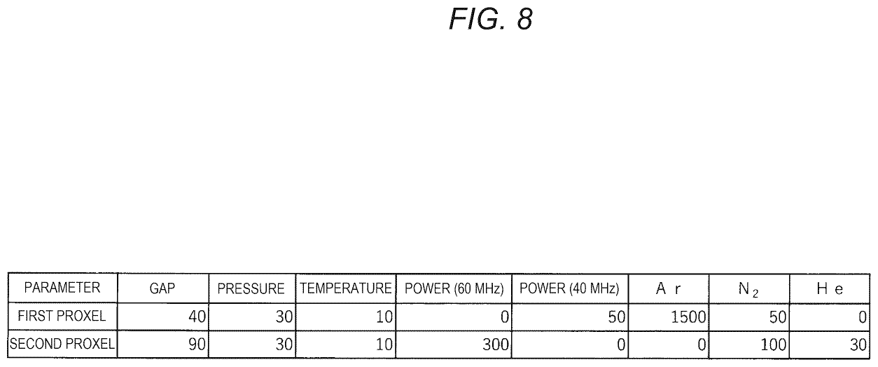

FIG. 8 is a table illustrating examples of a plurality of parameters related to two Proxels. Values of a plurality of parameters related to a first Proxel and a second Proxel are illustrated. Gap indicates a size of a gap between the two electrodes, and power (60 MHz) and power (40 MHz) indicate power of a voltage supplied to the process chamber at 60 MHz and power of a voltage supplied to the process chamber at 40 MHz. Ar, N₂, and He indicate respective flow rates of argon, nitrogen, and helium contained in gases supplied to the process chamber.

Values of the respective parameters related to a Proxel are discretized, and the calculator 11 uses, as a difference in values of the parameters, how many stages the values are changed in a discrete manner. The values of the parameters may be linearly discretized or may be non-linearly discretized. For example, the values of the gap are linearly discretized to 0, 10, 20 . . . . In the example illustrated in FIG. 8, values of the gap are 40 and 90 and change by 5 stages from 40 to 90, and thus a difference in values of the gap, which is one parameter, is 5. Values of the power are nonlinearly discretized to be 0, 10, 15, 20, 30, 50, 70, 100, 150 . . . . Since values of the power (60 MHz) have a difference of 10 stages and values of the power (40 MHz) have a difference of 5 stages, a difference in the values of the power (60 MHz) is 10, and a difference in the values of the power (40 MHz) is 5.

For example, it is assumed that a difference of the gas flow rates is nonlinearly discretized to 0, 0.1, 0.15, 0.2, 0.3, 0.5, 0.7, 1 . . . . Since values of Ar have a difference of 26 stages, values of N₂ have a difference of 2 stages, and values of He have a difference of 16 stages, a difference in the values of Ar is 26, a difference in the values of N₂ is 2, and a difference in the values of He is 16. The sum of the differences of the parameters is 5+0+0+10+5+26+2+16=64, which is a distance between the first Proxel and the second Proxel.

The calculator 11 may use other methods when the differences in the values of the respective parameters are calculated. For example, the calculator 11 may set an absolute value of a value obtained by simply subtracting a value in one Proxel from a value in the other Proxel as a difference in values of a parameter. For example, the calculator 11 may use a predetermined function or a conversion table to convert a subtracted value to obtain a difference in values of a parameter. The calculator 11 may execute a weighted summation when summing the differences in the parameters. For example, a weighting factor is determined in advance for each parameter, and the calculator 11 sums up values obtained by multiplying the differences in the parameters by the weighting factor. The calculator 11 may calculate the distance between Proxels based on the differences in values of a plurality of parameters by a method other than summation.

Next, the information processing device 1 executes clustering for the plurality of Proxels (S13). In S13, the calculator 11 executes clustering based on a predetermined value of a specific parameter. For example, the calculator 11 executes clustering according to a difference in gas having a largest flow rate among a plurality of gases used for the substrate processing. For example, a cluster that includes a Proxel in which a gas having a highest flow rate is Ar, a cluster in which a gas having a highest flow rate is He, and a cluster in which a gas having a highest flow rate is N₂ are created. The calculator 11 executes clustering based on values of flow rates of the respective gases.

The calculator 11 may execute clustering according to a parameter other than the gas having a highest flow rate, such as a combination of used gases or a difference in structures of the processing device 21. Whether to execute the clustering based on which parameter may be determined in advance, or may be input by a user operating the operation unit 15. The calculator 11 may execute the clustering based on a processing result included in the step data 134 of a processing step. The calculator 11 may execute the clustering according to information other than a plurality of parameters for defining contents of processing steps. For example, the clustering may be executed according to the number of processing steps included in a Proxel.

Next, the information processing device 1 calculates a distance between clusters (S14). In S14, the calculator 11 calculates the distance between clusters based on a value of a parameter used for clustering. For example, the calculator 11 calculates the distance based on a difference in gas having a largest flow rate between two clusters.

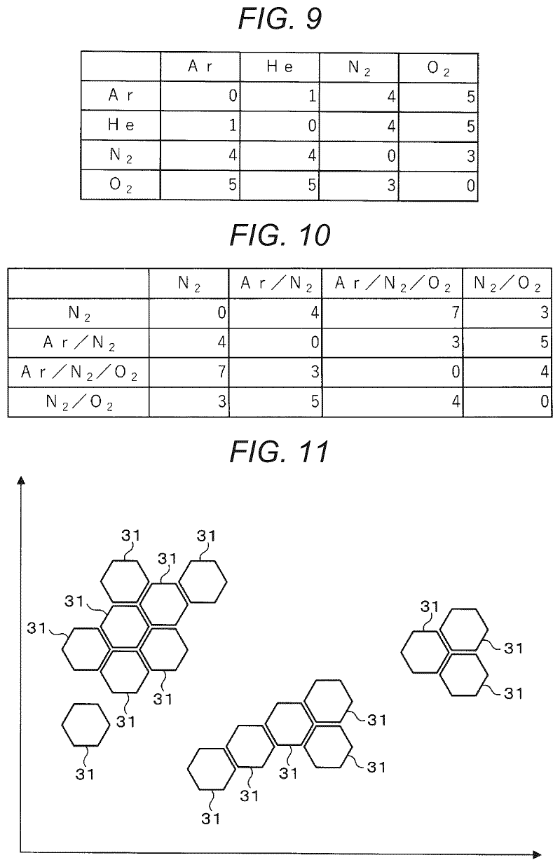

For example, a distance between two types of gases is determined in advance. FIG. 9 is a table illustrating an example of a distance defined between two types of gases. Distances between Ar, He, N₂, and O₂ (oxygen) are determined in advance. In the example illustrated in FIG. 9, a distance between Ar and He is 1, and a distance between Ar and the N₂ is 4. A distance between the other two types of gases is also defined. The predetermined distance between two types of gases is stored in advance in the storage 13. The calculator 11 sets the predetermined distance between gases having largest flow rates in two clusters as a distance between the clusters.

The calculator 11 may calculate the distance between clusters according to a difference in combination of gases used in each cluster. FIG. 10 is a table illustrating an example of a distance according to a difference in combination of gases. [Ar/N₂] indicates that a combination of Ar and N₂ is used, [Ar/N₂/O₂] indicates that a combination of Ar, N₂, and O₂ is used, and [N₂/O₂] indicates that a combination of N₂ and O₂ is used, as a combination of gases. Combinations of the gases are compared, a distance between the same gases is set to 0, a distance between other gases having a small value in total is adopted, and a gas that does not have a comparison target is compared with N₂, and obtained distances are summed to obtain a distance between clusters as illustrated in FIG. 10.

The calculator 11 may calculate a distance between clusters according to other parameters. For example, a distance is determined in advance according to a difference in structures of the processing device 21, and the calculator 11 sets a distance determined according to the difference in structures of the processing device 21 between two clusters as a distance between clusters. The calculator 11 may calculate a distance between clusters by any other method. For example, the calculator 11 calculates a distance between clusters by calculating and summing differences between values of specific parameters. For example, the calculator 11 may calculate a distance between clusters based on a difference between specific values included in processing results included in the step data 134 of processing steps.

Next, the information processing device 1 selects a cluster (S15). In S15, the calculator 11 selects one cluster from a plurality of created clusters. The information processing device 1 determines whether to execute clustering for Proxels included in the selected cluster (S16). In S16, for example, the calculator 11 determines whether to execute clustering based on the number of Proxels included in the selected cluster. For example, the calculator 11 determines to execute clustering when the number of Proxels exceeds a predetermined number.

The calculator 11 may determine whether to execute clustering based on a value of a specific parameter. For example, the calculator 11 determines to execute clustering when a difference between values of specific parameters in a plurality of Proxels exceeds a predetermined value. A user may input an instruction as to whether to execute clustering by operating the operation unit 15, and the calculator 11 may determine whether to execute clustering according to the input instruction.

When it is determined to execute clustering (S16: YES), the information processing device 1 returns the processing to S13. In S13, the calculator 11 executes clustering for a plurality of Proxels included in the selected cluster. When it is determined not to execute clustering (S16: NO), the information processing device 1 calculates coordinates of each Proxel in a two-dimensional coordinate space obtained by dimensionally compressing the process space (S17).

In S17, the calculator 11 calculates coordinates of each Proxel in the two-dimensional coordinate space by using multi-dimensional scaling (MDS) based on the distance between Proxels. The two-dimensional coordinate space is a space obtained by dimensionally compressing a multi-dimensional process space represented using a plurality of parameters. The calculator 11 converts the distance between the plurality of Proxels included in the selected cluster into coordinates in the two-dimensional coordinate space by using the multi-dimensional scaling, thereby calculating the coordinates of each Proxel. The coordinates of each Proxel calculated by the calculator 11 are relative coordinates. The calculator 11 calculates the coordinates of each Proxel to calculate a position in the two-dimensional coordinate space. The information processing device 1 may calculate coordinates of a Proxel by using an algorithm other than the multi-dimensional scaling.

Next, the information processing device 1 adjusts the calculated coordinates (S18). In S18, the calculator 11 adjusts relative coordinates of Proxels such that the coordinates of the Proxels in the two-dimensional coordinate space are not excessively separated from one another. For example, the calculator 11 adjusts the coordinates of the Proxels by normalizing a distance between coordinates of the Proxels. For example, a correspondence relationship between the adjusted distance and a distance between the coordinates of the Proxels is determined in advance, and the calculator 11 converts the distance between the coordinates of the Proxels according to the correspondence relationship, and adjusts the coordinates of the Proxels according to the converted distance. For example, with respect to two Proxels, the calculator 11 adjusts the coordinates of each Proxel so as to shorten the distance between the coordinates, while maintaining a direction in which the coordinates of one Proxel are located as viewing from the coordinates of the other Proxel in the two-dimensional coordinate space.

The calculator 11 selects a method for adjusting the coordinates according to the disposition of coordinates of a plurality of Proxels included in a cluster. For example, the calculator 11 selects a method for adjusting the coordinates according to a magnitude or a deviation of the distance between the coordinates of Proxels. The method for adjusting the coordinates may be different for each cluster. A method for adjusting the coordinates may be specified by a user operating the operation unit 15, and the calculator 11 may adjust the coordinates according to the specified method.

Next, the information processing device 1 determines whether there are unselected side-by-side clusters (S19). In S19, the calculator 11 determines whether there is a cluster beside the selected cluster and that has not been selected so far. For example, the side-by-side clusters are other clusters included in a cluster that includes the selected cluster. When there are unselected side-by-side clusters (S19: YES), the information processing device 1 returns the processing to S15. In S15, the calculator 11 selects the unselected side-by-side clusters.

When there is no unselected side-by-side clusters (S19: NO), the information processing device 1 determines whether there is an upper-level cluster (S20). The upper-level cluster is a cluster that includes the selected cluster. When there is an upper-level cluster (S20: YES), the information processing device 1 selects the upper-level cluster (S21).

Next, the information processing device 1 calculates coordinates of each Proxel included in the selected cluster in the two-dimensional coordinate space (S22). In S22, the calculator 11 calculates the coordinates of each Proxel in the selected cluster based on a distance between clusters included in the selected cluster and the coordinates of each Proxel in each cluster included in the selected cluster. The calculator 11 calculates relative coordinates of each Proxel such that coordinates of Proxels in each cluster included in the selected cluster are separated from one another by a distance corresponding to the distance between clusters.

Next, the information processing device 1 adjusts the calculated coordinates (S23). In S23, the calculator 11 adjusts relative coordinates of Proxels such that the coordinates of the Proxels in the two-dimensional coordinate space are not excessively separated from one another. Then, the information processing device 1 returns the processing to step S19.

When there is no upper-level cluster in S20 (S20: NO), the information processing device 1 calculates the coordinates of each Proxel in the two-dimensional coordinate space (S24). A cluster that is not included in other clusters is referred to as a top-level cluster. In S24, the calculator 11 calculates the coordinates of each Proxel based on a distance between the top-level clusters and the coordinates of each Proxel in each top-level cluster. The calculator 11 calculates the coordinates of each Proxel such that the coordinates of each Proxel in each top-level cluster are separated from one another by a distance corresponding to the distance between the top-level clusters. Next, the information processing device 1 adjusts the calculated coordinates (S25). In S25, the calculator 11 adjusts the coordinates of each Proxel such that the coordinates of the Proxels in the two-dimensional coordinate space are not excessively separated from one another.

Next, the information processing device 1 displays a graphic image illustrating each Proxel at the coordinates of each Proxel (S26). In S26, the calculator 11 creates an image in which the graphic image is disposed at the coordinates of each Proxel in the two-dimensional coordinate space, and displays the created image on the display unit 16. FIG. 11 is a schematic diagram illustrating an example of a two-dimensional coordinate space that includes a plurality of graphic images 31. In the drawing, a horizontal axis and a vertical axis represent two independent variables obtained by dimensionally compressing a plurality of parameters for defining contents of a processing step. The plurality of graphic images 31 are disposed in the two-dimensional coordinate space.

The graphic images 31 are located at positions corresponding to values of a plurality of parameters. When a distance between two Proxels is small, two of the graphic images 31 are disposed at close positions, and when a distance between two Proxels is large, two of the graphic images 31 are disposed at far positions. That is, a plurality of Proxels where the graphic images 31 are close to each other have similar parameter values. The plurality of graphic images 31 clustered in the coordinate space represent a plurality of Proxels included in a cluster. A user can visually recognize the plurality of graphic images 31 disposed in the two-dimensional coordinate space, and recognize how similar and different the plurality of Proxels are to each other.

The information processing device 1 adjusts a color of the graphic image 31 (S27). In S27, the calculator 11 adjusts the color of each graphic image 31 according to a value of a specific parameter related to each Proxel. A value of a used parameter is a representative value within a range related to each Proxel, or a value in a representative processing step included in each Proxel. For example, the color of the graphic image 31 is adjusted according to a value of a specific processing condition included in a plurality of parameters. For example, a relationship between a value of a processing condition and a color change is determined in advance such that as the value of the processing condition such as a pressure increases, the color is closer to blue, and as the value decreases, the color is closer to red. For example, a relationship between a value of a processing condition and the shade of color is determined in advance such that as the value of the processing condition increases, the color becomes darker, and as the value decreases, the color becomes lighter. For example, a table defining the relationship between a value of a processing condition and a color in such a manner is stored in advance in the storage 13.

For example, based on a relationship between a color and a value of a processing condition recorded in the table, the calculator 11 determines a color of the graphic image 31 according to a value of a specific processing condition included in a plurality of parameters related to a Proxel. The calculator 11 adjusts a color of the graphic image 31 to a determined color. A user can easily know a value of a parameter related to a Proxel, such as a value of a processing condition, according to the color of the graphic image 31.

In S27, the calculator 11 may adjust the color of the graphic image 31 according to a processing result of a processing step included in a Proxel. For example, the experimental result data included in the step data includes a measurement result obtained by the measurement device 23 measuring a shape of a substrate obtained through an experiment, the number of experiments, or an evaluation value for an experimental result. For example, the simulation result data includes a value of a parameter used in a shape simulation, the number of times the shape simulation is executed, or an evaluation value for a simulation result. For example, a table defining a relationship between a value of such a processing result and a color is stored in advance in the storage 13. For example, based on a relationship between a color and a value of a processing result recorded in the table, the calculator 11 determines a color of the graphic image 31 according to a value of a processing result recorded in the experimental result data or the simulation result data included in the step data related to a representative processing step included in a Proxel. The calculator 11 adjusts a color of the graphic image 31 to a determined color. A user can easily know a processing result of a processing step included in a Proxel according to the color of the graphic image 31.

In S27, the calculator 11 may adjust the color of the graphic image 31 based on a Loss value in an experiment and a Loss value in a simulation. For example, a table defining a relationship between a Loss value and a color is stored in advance in the storage 13. Based on the relationship between the Loss value and the color recorded in the table, the calculator 11 determines the color of the graphic image 31 according to Loss values included in the experimental result data and the simulation result data. The calculator 11 adjusts a color of the graphic image 31 to a determined color.

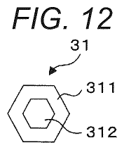

FIG. 12 is a schematic diagram illustrating an example of the graphic image 31 in which a color is adjusted according to a Loss value in an experiment and a Loss value in a simulation. The graphic image 31 is divided into two regions of a first region 311 and a second region 312. The calculator 11 adjusts a color of the first region 311 according to a Loss value in an experiment included in the experimental result data. Further, the calculator 11 adjusts a color of the second region 312 according to a Loss value in a simulation included in the simulation result data.

Since the color of the graphic image 31 is adjusted according to the Loss value, a user who sees the graphic image 31 can recognize an approximate value of the Loss value based on the color of the graphic image 31. As the Loss value in the experiment or the simulation increases, a difference between an experimental result or a simulation result and a target shape increases. A user can confirm accuracy of the experiment and the shape simulation according to the color of the graphic image 31. The information processing device 1 may adjust the color of the graphic image 31 according to only one of the Loss value in the experiment or the Loss value in the simulation.

Which information among a plurality of parameters including a processing result is used to adjust the color of the graphic image 31 may be preset or selected by a user. For example, the user operates the operation unit 15 to specify information, and the calculator 11 adjusts the color of the graphic image 31 according to the specified information. For example, the user selects as to whether the color of the graphic image 31 is to be adjusted based on which value of a processing condition included in the plurality of parameters.

A relationship between contents of a processing step and the color of the graphic image 31 may include a plurality of patterns. For example, a table recording a plurality of patterns is stored in the storage 13, the user selects a pattern by operating the operation unit 15, and the calculator 11 adjusts the color of the graphic image 31 according to the selected pattern. The user can easily confirm contents of a processing step by using an easy-to-see color. When the graphic image 31 collectively represents a plurality of processing steps, the color of the graphic image 31 may be adjusted according to information related to any one processing step, or the color of the graphic image 31 may be adjusted according to information obtained by averaging information related to the plurality of processing steps.

Instead of adjusting the color of the graphic image 31 in S27, the information processing device 1 may adjust a size or a shape of the graphic image 31 according to a value of a specific parameter related to each Proxel. For example, the calculator 11 may increase the size of the graphic image 31 as the value of the specific parameter increases. For example, the calculator 11 may change the shape of the graphic image 31 from a figure drawn by a single line as illustrated in FIG. 11 to a figure drawn by a double line, a figure drawn by a triple line, or the like, according to the value of the specific parameter. For example, the calculator 11 may change the shape of the graphic image 31 from a triangle to another shape such as a square, a pentagon, and a hexagon according to the value of a specific parameter.

After S27, the information processing device 1 ends the processing of displaying a relationship among processing steps. Through the processing in S11 to S27, the plurality of graphic images 31 representing a plurality of Proxels are displayed in the two-dimensional coordinate space. A plurality of processing steps having substantially the same contents are grouped into one Proxel and represented by one graphic image 31. Therefore, it is not complicated to display a plurality of processing steps. Processing steps having different contents are included in different Proxels, and a relationship among the processing steps included in the Proxel is clear according to a positional relationship of the graphic images 31 representing the Proxels. That is, a user can recognize a relationship among the processing steps of how similar and different the processing steps included in the Proxels are by recognizing a relationship among a plurality of Proxels according to a positional relationship of the graphic images 31.

In the processing of S11 to S27, by executing clustering, a plurality of the graphic images 31 representing a plurality of Proxels having similar specific features are displayed collectively at close positions. When the clustering is not executed, a plurality of the graphic images 31 representing a plurality of Proxels having similar features may be dispersedly displayed. By executing the clustering, the plurality of graphic images 31 representing a plurality of similar Proxels are collectively displayed, so that a user can easily recognize a relationship among processing steps.

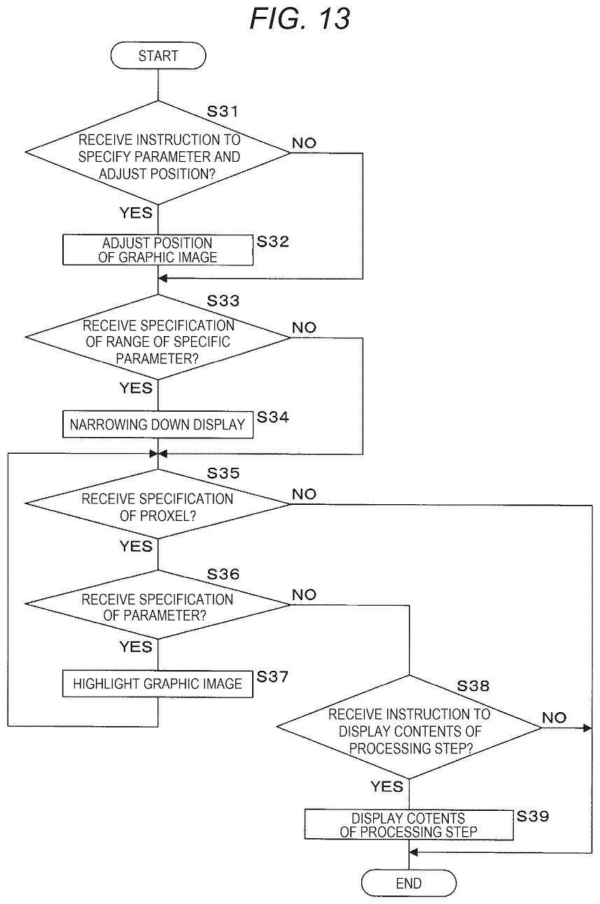

The information processing device 1 can execute information processing that changes the display of the graphic image 31. FIG. 13 is a flowchart illustrating an example of a processing procedure of changing the display of the graphic image 31, which is executed by the information processing device 1. The information processing device 1 waits for reception of an instruction to specify a parameter and adjust a position of the graphic image 31 (S31). In S31, the calculator 11 receives an instruction to specify one parameter and adjust the position of the graphic image 31 by a user operating the operation unit 15. When an instruction to specify a parameter and adjust a position of the graphic image 31 is received (S31: YES), the information processing device 1 adjusts the position of the graphic image 31 in the two-dimensional coordinate space according to the specified parameter (S32).

In S32, the calculator 11 calculates a distance between Proxels related to the specified parameter. For example, the calculator 11 calculates a difference in values of the specified parameter between the Proxels, and sets the calculated difference as a distance between Proxels. The calculator 11 adjusts coordinates of Proxels in the two-dimensional coordinate space according to the calculated distance between Proxels. More specifically, the calculator 11 recalculates coordinates of each two Proxels such that as a distance between the two Proxels decreases, relative coordinates of the two Proxels become closer, and as the distance between the two Proxels increases, the relative coordinates of the two Proxels become farther. At this time, the coordinates may be recalculated such that the specified parameters become one axis in the two-dimensional coordinate space. The calculator 11 creates an image obtained by disposing the graphic image 31 at coordinates of each Proxel recalculated in the two-dimensional coordinate space, and displays the created image on the display unit 16.

In the two-dimensional coordinate space, the graphic image 31 is fixed according to a difference in values of a specific parameter. A user can confirm a difference in Proxels related to the specific parameter. Therefore, the user can confirm a relationship among processing steps in relation to the specific parameter.

When the instruction to specify a parameter and adjust a position of the graphic image 31 is not received (S31: NO), or after S32 is completed, the information processing device 1 waits for reception of specification of a range of the specific parameter (S33). In S33, the calculator 11 receives specification of a range of one parameter by the user operating the operation unit 15. When the specification of the range of the specific parameter is received (S33: YES), the information processing device 1 narrows down Proxels for displaying the graphic images 31 (S34).

In S34, the calculator 11 clearly displays the graphic image 31 representing a Proxel included in a range in which the value of the specific parameter is specified, and does not clearly display the graphic image 31 representing a Proxel that is not included in the range in which the value of the specific parameter is specified. The calculator 11 creates an image in which the graphic image 31 representing a Proxel included in the range in which the value of the specific parameter is specified is clearly displayed and the graphic images 31 representing the other Proxels are not displayed, and displays the created image on the display unit 16. Alternatively, the calculator 11 displays an image in which the graphic images 31 representing the other Proxels are unclear on the display unit 16. For example, the graphic images 31 representing the other Proxels are drawn by a line unclear than a solid line, such as a broken line or a dotted line. For example, the graphic images 31 representing the other Proxels are displayed in a lighter color, a darker color, or lower brightness. In S34, the information processing device 1 may execute processing of displaying, in a highlight manner, the graphic image 31 representing a Proxel included in the range in which the value of the specific parameter is specified, as compared with the graphic images 31 representing the other Proxels.

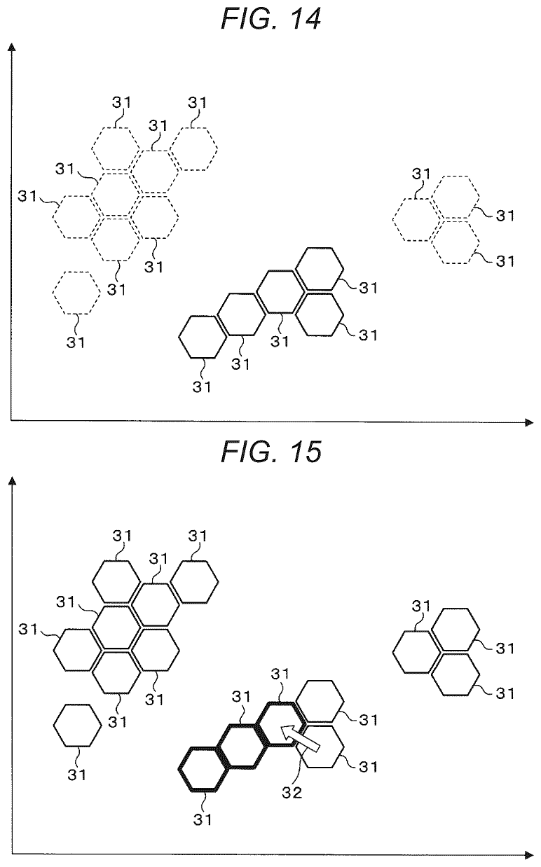

FIG. 14 is a schematic diagram illustrating an example of a two-dimensional coordinate space in which Proxels for displaying the graphic images 31 are narrowed down. The graphic image 31 representing a Proxel included in the range in which the value of the specific parameter is specified is illustrated by a solid line, and the other graphic images 31 are illustrated by broken lines. In this manner, the Proxels for displaying the graphic images 31 are narrowed down. Since the graphic image 31 that is clearly displayed is limited, a user can confirm a relationship among Proxels included in the range in which the value of the specific parameter is specified. In other words, the user can confirm a relationship among processing steps within a limited range.

When the specification of the range of the specific parameter is not received (S33: NO), or after S34 is completed, the information processing device 1 waits for reception of specification of a Proxel (S35). In S35, the calculator 11 receives specification of a Proxel by a user operating the operation unit 15. For example, the user operates the operation unit 15 to place a cursor on the graphic image 31 on a screen of the display unit 16, thereby specifying a Proxel corresponding to the graphic image 31. When the specification of the Proxel is not received (S35: NO), the information processing device 1 ends the processing of changing the display of the graphic image 31.

When the specification of the Proxel is received (S35: YES), the information processing device 1 waits for the specification of a specific parameter (S36). In S36, the calculator 11 receives the specification of the specific parameter by the user operating the operation unit 15. When the specification of the specific parameter is received (S36: YES), the information processing device 1 highlights the graphic image 31 representing a Proxel different from the Proxel in which the value of the specified parameter is specified (S37).

In S37, the calculator 11 selects, from a plurality of Proxels, a Proxel in which the value of the specified parameter is different from that of the specified Proxel and values of the other parameters are the same as those of the specified Proxel. The calculator 11 creates an image in which the graphic image 31 representing the selected Proxel and the graphic image 31 representing the specified Proxel are highlighted, and displays the created image on the display unit 16.

FIG. 15 is a schematic diagram illustrating an example of a two-dimensional coordinate space in which some of the graphic images 31 are highlighted. A Proxel is specified by placing a cursor 32 on the graphic image 31. The graphic image 31 representing the specified Proxel and the graphic image 31 representing a Proxel in which the value of the specified parameter is different from that of the specified Proxel and the values of the other parameters are the same as those of the specified Proxel are highlighted by forming the graphic images 31 with thick lines. The calculator 11 may highlight the graphic image 31 by a method other than the method using a thick line. For example, the calculator 11 highlights the graphic image 31 by changing a color of the graphic image 31, changing a shape or a size of the graphic image 31, or flashing the graphic image 31.

A user can confirm a Proxel in which the value of the specified parameter is different from that of the specified Proxel and the values of the other parameters are the same as those of the specified Proxel. For example, the user can easily search for another Proxel in which the value of the specified parameter is different from that of the specified Proxel, and specify the searched Proxel. After step S37 is completed, the information processing device 1 returns the processing to step S35.

When the specification of the specific parameter is not received (S36: NO), the information processing device 1 waits for reception of an instruction to display contents of a processing step (S38). In S38, the calculator 11 receives the instruction to display contents of a processing step included in the specified Proxel by a user operating the operation unit 15. When the instruction to display contents of the processing step is received (S38: YES), the information processing device 1 displays the contents of the processing step included in the specified Proxel (S39).

In S39, the calculator 11 creates an image representing contents of the processing step based on the step data related to the processing step included in the specified Proxel, and displays the created image on the display unit 16. At this time, the calculator 11 displays contents of a plurality of processing steps included in the Proxel on the display unit 16.

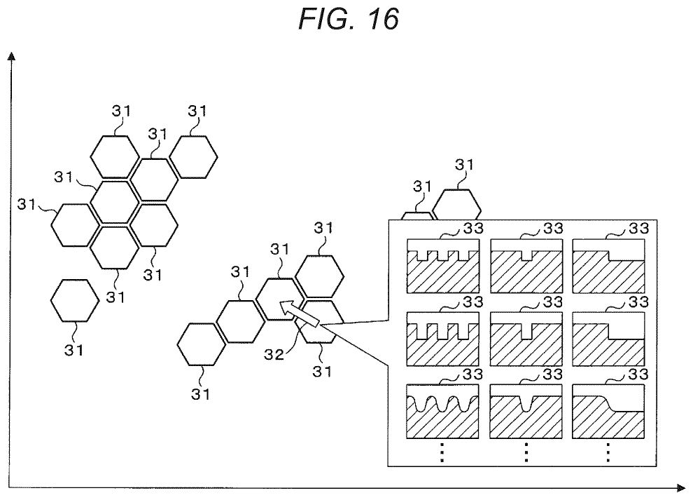

FIG. 16 is a schematic diagram illustrating a display example of contents of processing steps. A Proxel is specified by placing the cursor 32 on the graphic image 31. The contents of the plurality of processing steps included in the specified Proxel are displayed. FIG. 16 illustrates an example in which experimental results 33 are displayed as the contents of the processing steps. The calculator 11 displays a plurality of the experimental results 33 on the display unit 16 based on the experimental result data included in the step data related to the plurality of processing steps included in the specified Proxel. The experimental result 33 is, for example, a result obtained by executing an experiment in which the processing device 21 executes substrate processing according to a processing step, and measuring a cross-section of the substrate obtained in the experiment by the measurement device 23.

Simulation results of processing steps may be displayed as contents of the processing steps. A recipe name or a processing step may be further displayed. Other kinds of information recorded in the step data, such as a processing condition, may be displayed as the contents of the processing steps. Alternatively, a list of a plurality of processing steps included in the specified Proxel may be displayed. A processing step may be specified from the list by a user operating the operation unit 15, and the calculator 11 may display contents of the specified processing step on the display unit 16.

Through the processing in S39, the user can confirm the contents of the processing steps included in the Proxel. The user can specify any one Proxel by using the plurality of displayed graphic images 31 and can confirm contents of processing steps included in the Proxel. The user can confirm a difference in the contents of the processing steps according to a difference in Proxel by confirming the contents of the processing steps while changing the specified Proxel.

When the instruction to display the contents of the processing steps is not received (S38: NO), or after step S39 is completed, the information processing device 1 ends the processing of changing the display of the graphic image 31. The information processing device 1 executes information processing in S31 to S39 as appropriate. For example, each time information is input by the user operating the operation unit 15 in a state where the graphic image 31 is displayed on the display unit 16, the information processing device 1 executes the information processing in S31 to S39.

As described in detail above, in the present embodiment, the information processing device 1 combines a plurality of processing steps having substantially the same contents among a plurality of processing steps included in a plurality of recipes into one Proxel, and displays a plurality of the graphic images 31 representing a plurality of Proxels in a two-dimensional coordinate space. The graphic images 31 are displayed at positions corresponding to values of a plurality of parameters for defining contents of processing steps in the two-dimensional coordinate space. Since the graphic images 31 are displayed at positions corresponding to contents of processing steps, a relationship among processing steps included in a Proxel is visualized such that contents of processing steps are similar when the positions are close and contents of processing steps are different from one another when the positions are far. A user can recognize the relationship among processing steps. The relationship among processing steps may be used to search for a new recipe, such as employing a processing step that has a particular relationship with a processing step included in a recipe or creating a new processing step having contents different from contents of an existing processing step.

In the present embodiment, the graphic image 31 is displayed in the two-dimensional coordinate space. Alternatively, the information processing device 1 may execute information processing for displaying the graphic image 31 in a three-dimensional coordinate space. In the embodiment, the information processing device 1 displays, on the display unit 16, an image representing a coordinate space having three axes representing three independent variables obtained by dimensionally compressing a plurality of parameters for defining contents of processing steps. In the embodiment, a user can recognize a relationship among processing steps based on a position of the graphic image 31 in a coordinate space.

The invention is not limited to contents of the above-described embodiment, and various modifications may be made within the scope described in the following claims. In other words, embodiments obtained by combining technical means appropriately changed within the scope indicated in the claims are also included in the technical scope of the invention.

The features described in each embodiment can be combined with each other. In addition, the independent and dependent claims set forth in the claims can be combined with each other in any and all combinations, regardless of the reciting format. Furthermore, the claims use a format of describing claims that recite two or more other claims (multi-claim format). However, the present disclosure is not limited thereto. The claims may also be described using a format of multi-claims reciting at least one multi-claim (multi-multi claims).

1. A computer program for causing a computer to:
acquire processing step groups obtained by classifying processing steps executed for processing a substrate, based on a range of values of parameters for defining contents of the processing steps, and
display a graphic image representing each processing step group at positions corresponding to the values of the parameters related to each processing step group in a two-dimensional or three-dimensional coordinate space obtained by dimensionally compressing a multi-dimensional space represented using the parameters.

2. The computer program according to claim 1, wherein
the computer is further caused to
calculate a distance between the processing step groups related to the parameters based on a difference between the values of the parameters related to each processing step group, and
display the graphic image at a position in the coordinate space related to each processing step group calculated based on the distance.

3. The computer program according to claim 2, wherein
the computer is further caused to
cluster the processing step groups based on a value of a specific parameter,
calculate a distance between clusters based on a difference between the values of the specific parameters, and
display the graphic image at a position in the coordinate space related to each processing step group calculated based on the distance between the clusters and a distance between the processing step groups included in the clusters.

4. The computer program according to claim 3, wherein
the computer is further caused to
cluster processing step groups included in one cluster, and
calculate a position in the coordinate space related to each processing step group based on the distance between the clusters, a distance between clusters in the cluster, and the distance between the processing step groups in the cluster.

5. The computer program according to claim 1, wherein
the computer is further caused to
receive specification of a parameter, and
adjust a position in the coordinate space related to each processing step group based on a distance between the processing step groups related to the specified parameter.

6. The computer program according to claim 1, wherein
the computer is further caused to
receive specification of a processing step group, and
display contents of processing steps included in the specified processing step group.

7. The computer program according to claim 1, wherein
the computer is further caused to
receive specification of a range of a specific parameter, and
narrow down the processing step group for displaying the graphic image according to the specified range of the specific parameter.

8. The computer program according to claim 1, wherein
the computer is further caused to
receive specification of a processing step group and specification of a parameter, and
highlight a graphic image representing another processing step group different from a processing step group in which a value of the specified parameter is specified.

9. The computer program according to claim 1, wherein
the computer is further caused to adjust a color of the graphic image according to a value of a specific parameter.

10. The computer program according to claim 9, wherein
the processing step group includes a Loss value based on an experimental result and a Loss value based on a simulation result, and
the computer is caused to divide the graphic image into two regions, adjust one of the regions according to the Loss value based on the experimental result, and adjust the other region according to the Loss value based on the simulation result.

11. An information processing method comprising:
acquiring processing step groups obtained by classifying processing steps executed for processing a substrate, based on a range of values of parameters for defining contents of the processing steps, and
displaying a graphic image representing each processing step group at positions corresponding to the values of the parameters related to each processing step group in a two-dimensional or three-dimensional coordinate space obtained by dimensionally compressing a multi-dimensional space represented using the parameters.

12. An information processing device comprising:
a calculator, wherein
the calculator is configured to
acquire processing step groups obtained by classifying processing steps executed for processing a substrate, based on a range of values of parameters for defining contents of the processing steps, and
display a graphic image representing each processing step group at positions corresponding to the values of the parameters related to each processing step group in a two-dimensional or three-dimensional coordinate space obtained by dimensionally compressing a multi-dimensional space represented using the parameters.
